(19) United States
(12) Patent Application Publication
(10) Pub. No.: US 2021/0015037 A1
(43) Pub. Date: Jan. 21, 2021

(54) DUAL BLADE WIDE-FORMAT LAWN MOWER

(71) Applicant: YANGZHOU WEIBANG GARDEN MACHINE COMPANY LIMITED, Yangzhou (CN)

(72) Inventors: Yi WU, Yangzhou (CN); Zhongyu KE, Yangzhou (CN); Jian BAO, Yangzhou (CN)

(21) Appl. No.: 16/924,733

(22) Filed: Jul. 9, 2020

(30) Foreign Application Priority Data
Jul. 19, 2019 (CN) 201921136362.8

(51) Int. Cl. A01D 34/73; A01D 34/76

(52) U.S. Cl. CPC A01D 34/73; A01D 2101/00; A01D 34/76

(57) ABSTRACT

Dual blade wide-format lawn mower, with an engine on the chassis, and a grass cutter disc that includes two parallel cutter shafts, each with a cutting blade on an lower end; each with a cutter shaft bevel gear on the top end, each engaged with a transmission bevel gear on an outer end of a horizontal shaft; both horizontal shafts are co-axial, each shaft and same side cutter shaft supported by a bearing in a cutter shaft seat; fixed onto the chassis, and opposing ends of both shafts extend from the respective cutter shaft seat and mounted with a drum-type gear, both engaged respectively with spline internal teeth at both ends of an internally toothed sleeve; one cutter shaft upper end extends the cutter shaft seat and is mounted with a cutter shaft pulley transmission connected with an engine pulley via driving belt.

### FIELD OF THE INVENTION

The present invention relates to a lawn mower, and more specifically, to a dual blade wide-format lawn mower which can be used for grass cutting operations in parks, fields or green belts.

### BACKGROUND OF THE INVENTION

With the requirements for city greening, lawn coverage becomes higher and higher, and artificial lawn planting industrial chain are thriving. Large and medium sized lawn mowing machines become widely used in many places such as parks, fields and lawn bases. A conventional lawn mower comprises a chassis, an engine mounted onto the chassis, and a cutter disc mounted under the chassis; the cutter disc is generally provided with a cutting blade that can be rotated at high speed; an output end of an crankshaft of the engine is mounted with an engine pulley which drives a cutter shaft via a belt, thereby driving the cutting blade to rotate.

A lawn mower having only one cutting blade can cover a relatively narrow width when it advances. In order to improve grass cutting efficiency, dual blade wide-format lawn mower emerged. A dual blade wide-format lawn mower employs two cutter shafts, with each cutter shaft being mounted with a cutting blade on the lower end thereof. Conventionally, each of the two cutter shafts is mounted with a cutter shaft pulley which is driven by an engine pulley via a belt.

Since both cutting blades rotate at high sped separately, they both will move and pass a region located between the two cutter shafts. Therefore, phase staggering of the two cutting blades is required such that they are able to run through the connection line between the two cutter shafts alternately. Since belt transmission is prone to skidding, the phase difference of the two cutting blades may change easily. Once the two cutting blades pass the connection line between the two cutter shafts at the same time, they will collide and be damaged. Since generally a lawn ground surface is not completely flat, the relative positions of the two cutter shafts would become variable, and thus a rigid transmission would result in damages.

### SUMMARY OF THE INVENTION

It is an objective of the present invention to overcome the flaws present in prior art and provide a dual blade wide-format lawn mower which can carry out grass cutting simultaneously at the same height with two interconnected dual blades. The transmission is reliable and has low failure rate.

For solving the technical problem described above, the present invention provides a dual blade wide-format lawn mower comprising: a chassis, an engine mounted on the chassis, and a grass cutter disc mounted under the chassis; the grass cutter disc comprises two cutter shafts parallel with each other; the two cutter shafts each are mounted with a cutting blade on an lower end thereof; the two cutter shafts each are mounted with a cutter shaft bevel gear on a top end thereof, and each cutter shaft bevel gear is engaged with a transmission bevel gear mounted respectively on an outer end of a horizontal shaft; the two horizontal shafts are co-axial, and each horizontal shaft and the cutter shaft on the same side with said each horizontal shaft are supported respectively by a bearing in a cutter shaft seat; both cutter shaft seats are fixed onto the chassis, and opposing ends of the two horizontal shafts extend from the respective cutter shaft seat and each is mounted with a drum-type gear, and both drum-type gears are engaged respectively with spline internal teeth provided at both ends of an internally toothed sleeve; one cutter shaft has an upper end that extends from a top end of the respective cutter shaft seat and the upper end is mounted thereon with a cutter shaft pulley that is connected with an engine pulley via a cutter disc driving belt.

Compared to the prior art, the present invention achieves the following beneficial effects: The engine drives the cutter shaft pulley to rotate via the engine pulley and the cutter disc driving belt. The cutter shaft pulley drives a first cutter shaft to rotate, so as to drive a first cutting blade on the lower end of the first cuter shaft to rotate at a high speed. A first cutter shaft bevel gear on the first cutter shaft drives a first transmission bevel gear to rotate, which in turn drives a first horizontal shaft to rotate. The first horizontal shaft drives a first drum-type gear to rotate, and the first drum-type gear then drives the internally toothed sleeve to rotate via the spline internal teeth provided at one end thereof. The internally toothed sleeve drives a second drum-type gear to rotate via the spline internal teeth provided at the other end thereof, and the second drum-type gear drives a second horizontal shaft to rotate. A second transmission bevel gear at the other end of the second horizontal shaft drives a second cutter shaft bevel gear to rotate, and the second cutter shaft bevel gear then drives a second cutter shaft and a second cutting blade on the lower end of the second cutter shaft to rotate at a high speed with the direction of rotation being opposite to the direction of rotation of the first cutting blade. The engagement of the first drum-type gear and the second drum-type gear with the spline internal teeth is with sufficient flexibility so that a flexible transmission can be achieved, so as to automatically compensate for the coaxial error and spacing error of the first horizontal shaft and the second horizontal shaft, thereby adapting to a bumpy environment of grassland.

As an improvement of the invention, the grass cutter disc is provided with a grass cutter disc cover that is connected with a discharge chute at a middle portion of a rear side of the grass cutter disc cover, an rear outlet of the discharge chute is connected with a front inlet of a grass collection basket, and the grass collection basket and the grass cutter disc cover are fixedly mounted onto the chassis. The first cutting blade and the second cutting blade rotate in opposite directions and all grass cut down by the two cutting blades is discharged from the discharge chute provided at the middle portion of the rear side of the grass cutter disc cover and introduced into the grass collection basket for temporary storage.

As a further improvement of the invention, the two cutting blades have a phase position difference of 90 degrees. Therefore, collision of the two blades can be avoided to the full extent and achieve a continuous discharge of cut-down grass.

As a further improvement of the invention, the drum-type gear is formed by joining two symmetrical halves in the thickness direction and the joining locations are provided with tenons and slots that match the tenons respectively. The drum-type gear is divided into two bevel gears at the highest place of the addendum. After the two bevel gears are made separately, they are joined together back-to-back and tightened in the axial direction. With the tenons being inserted into the slots, fast alignment of the two halves of the drum-type gear and precise positioning in the radial direction can be readily achieved.

As a further improvement of the invention, the internally toothed sleeve and a periphery of the two cutter shaft seats are covered with a drive mechanism shield. The drive mechanism shield can keep grass cuttings and dust out, thereby improving the reliability of the drive system.

As a further improvement of the invention, a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state. Upon the separation and engagement cable being tensioned, the cutter disc separation and engagement arm overcomes the stretching force of the separation and engagement arm pullback spring and swings clockwisely, which causes the tensioning wheel to be pressed against the cutter disc driving belt, thereby driving the cutter shaft pulley to rotate by the engine pulley via the disc cutter disc driving belt.

As a further improvement of the invention, a brake disc is fixedly provided under the engine pulley and a mating brake block is provided at a periphery of the brake disc, a driving end of the brake block is fixed onto the long arm end of the cutter disc separation and engagement arm. Upon the separation and engagement cable being released, the pull force of the separation and engagement arm pullback spring causes the cutter disc separation and engagement arm to swing counter clockwisely, and with the tensioning wheel going away from the cutter disc driving belt, the brake block is pressed tightly against the brake disc and the cutter shaft pulley is stopped immediately.

### BRIEF DESCRIPTION OF THE DRAWINGS

FIG. 1 is a perspective view of the dual blade wide-format lawn mower of the present invention.

FIG. 2 is a perspective view of the cutter disc driving mechanism of FIG. 1.

FIG. 3 is a perspective view of the cutter disc driving mechanism of FIG. 2, but the cutter disc cover is removed.

FIG. 4 is a perspective view of the cutter disc cover of FIG. 2.

FIG. 5 is a top view of the driving wheels and the cutter disc driving mechanism.

FIG. 6 is cross-sectional view of the cutter disc driving mechanism.

FIG. 7 is a structural schematic diagram of the drum-type gear.

FIG. 8 is an exploded view of the driving mechanism for the interconnected dual blades.

In the figures:
1a first cutter shaft seat
1b second cutter shaft seat
2a first cutter shaft
2a1 first cutter shaft bevel gear
2a2 cutter shaft pulley
2b second cutter shaft
2b1 second cutter shaft bevel gear
3a first cutting blade
3b second cutting blade
4a first horizontal shaft
4a1 first transmission bevel gear
4a2 first drum-type gear
4b second horizontal shaft
4b1 second transmission bevel gear
4b2 second drum-type gear
4c tenon
5 internally toothed sleeve
6 cutter disc driving belt
7 engine
7a engine crankshaft
7b engine pulley
8 cutter disc separation and engagement arm
8a tensioning wheel
8b separation and engagement arm spindle
8c brake block
8d separation and engagement arm pullback spring
9 cutter disc separation and engagement cable
10 brake disc
11 cutter disc cover
11a discharge chute
12 grass collection basket
13 drive mechanism shield
14 handrail
15 walking belt

### DETAILED DESCRIPTION OF THE INVENTION

In the description of the present invention provided below, the terms indicating directional or positional relationships such as “front”, “rear”, “left”, “right”, “inner”, “inside”, “internal”, “outer” and “outside” are based on the directional or positional relationships shown in the accompanying drawings and used merely for facilitating the description of the present invention and making the description simple, but not for defining that the lawn mower must have the particular directions and/or positions.

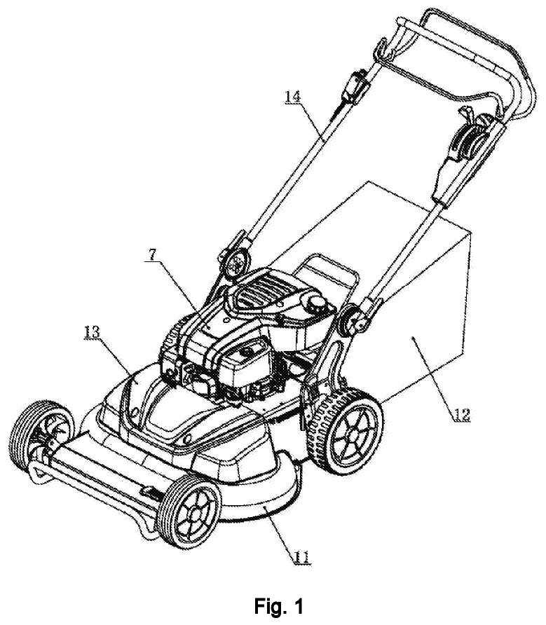

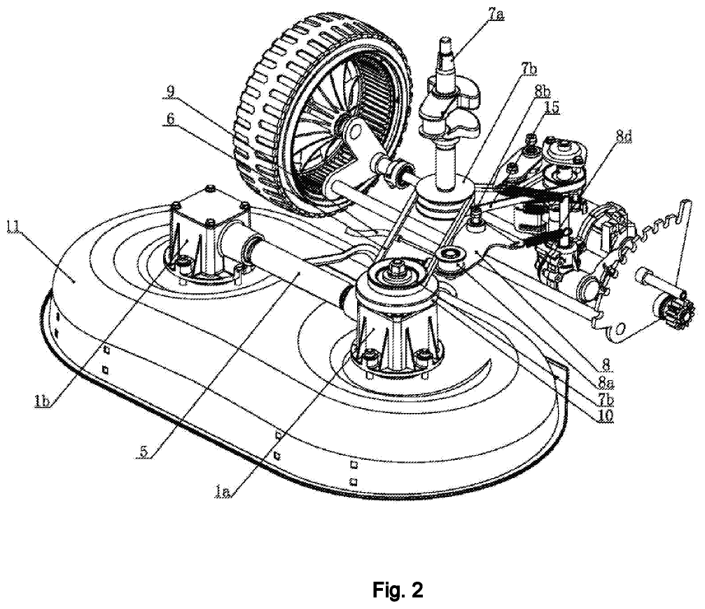

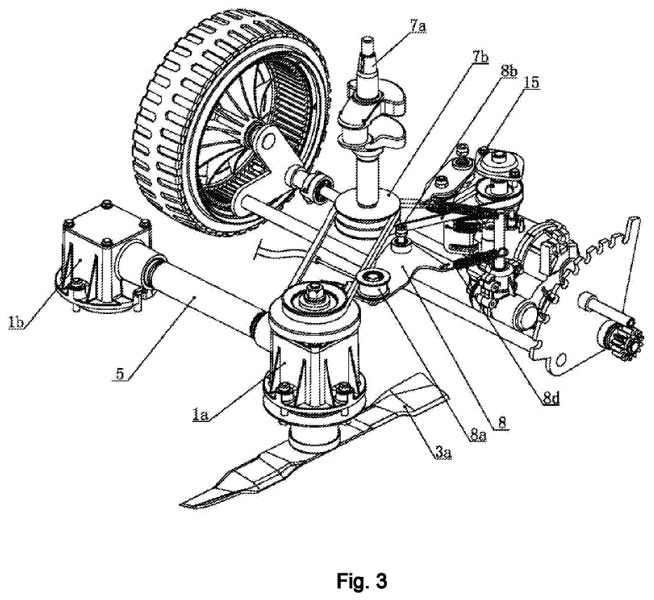

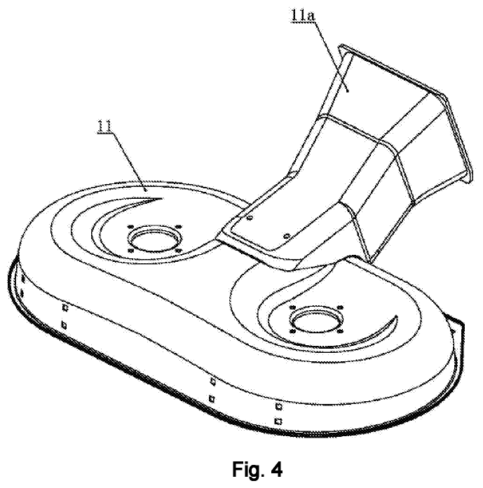

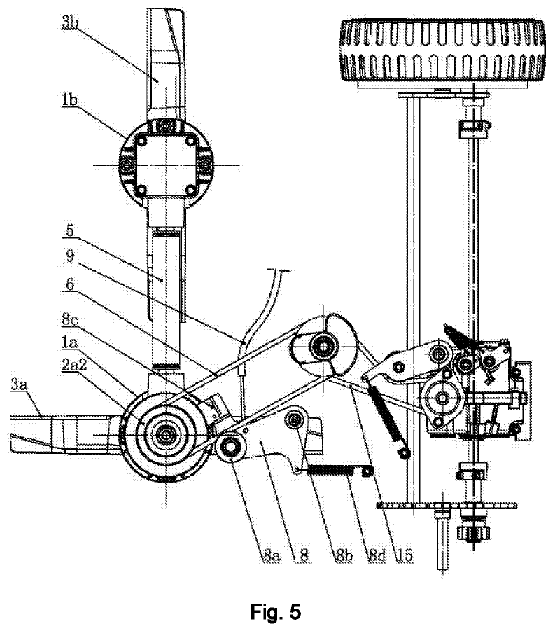

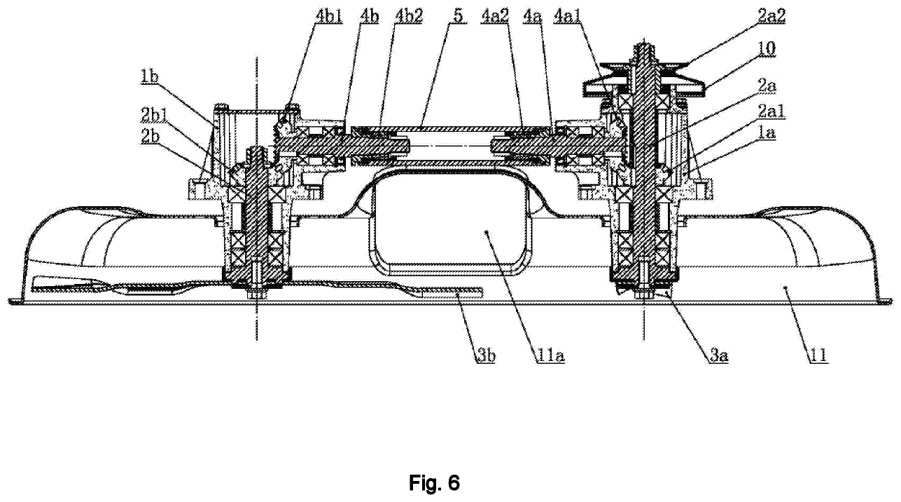

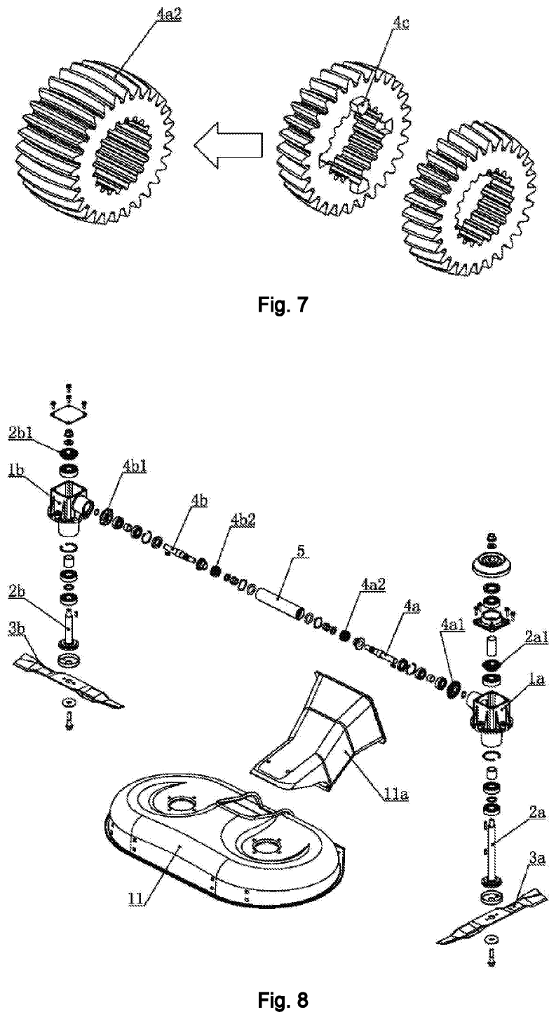

As shown in FIGS. 1-8, the dual blade wide-format lawn mower of the present invention comprises a chassis, and the chassis is mounted thereon with an engine 7, and a grass cutter disc mounted under the chassis. The grass cutter disc comprises a first cuter shaft 2a and a second cutter shaft 2b parallel with the first cuter shaft 2a. The first cuter shaft 2a is mounted with a first cutting blade 3a on the lower end thereof. A cutter shaft bevel gear 2a1 is mounted on the upper end of the first cuter shaft 2a, and the cutter shaft bevel gear 2a1 is engaged with a first transmission bevel gear 4a1 mounted on an outer end of a first horizontal shaft 4a. The first horizontal shaft 4a and the first cuter shaft 2a are supported respectively by a bearing in a first cutter shaft seat 1a.

The second cuter shaft 2b is mounted with a second cutting blade 3b on the lower end thereof. A second cutter shaft bevel gear 2b1 is mounted on the upper end of the second cuter shaft 2b, and the second cutter shaft bevel gear 2b1 is engaged with a second transmission bevel gear 4b1 mounted on an outer end of a second horizontal shaft 4b. The second horizontal shaft 4b and the second cuter shaft 2b are supported respectively by a bearing in a second cutter shaft seat 1b.

Both the first cutter shaft seat 1a and the second cutter shaft seat 1b are fixed on the chassis. The first horizontal shaft 4a and the second horizontal shaft 4b are co-axial. The first horizontal shaft 4a has an inner end that extends from the first cutter shaft seat 1a and is mounted with a first drum-type gear 4a2; the second horizontal shaft 4b has an inner end that extends from the first cutter shaft seat 1b and is mounted with a second drum-type gear 4b2. The first drum-type gear 4a2 and the second drum-type gear 4b2 are engaged respectively with spline internal teeth provided at both ends of an internally toothed sleeve 5. The first cuter shaft 2a has an upper end that extends from the top of the first cutter shaft seat 1a and the upper end is mounted thereon with a cutter shaft pulley 2a2 that is transmission connected with an engine pulley 7b by a cutter disc driving belt.

The engine pulley 7b is mounted on a lower end of an engine crankshaft 7a of the engine 7. The engine pulley 7b is connected with a self-propelled gear box by a belt, so as to drive the wheels. An operator controls the forward moving direction by a handrail 14. The engine pulley 7b also drives the cutter shaft pulley 2a2 to rotate by a cutter disc driving belt 6. The cutter shaft pulley 2a2 drives the first cutter shaft 2a to rotate, so as to drive the first cutting blade 3a on the lower end of the first cuter shaft 2a to rotate at a high speed. The cutter shaft bevel gear 2a1 on the first cutter shaft 2a drives the first transmission bevel gear 4a1 to rotate, which drives the first horizontal shaft 4a to rotate. The first horizontal shaft 4a drives the first drum-type gear 4a2 to rotate, and the first drum-type gear 4a2 then drives the internally toothed sleeve 5 to rotate via the spline internal teeth provided at one end thereof. The internally toothed sleeve 5 drives the second drum-type gear 4b2 to rotate via the spline internal teeth provided at the other end thereof, and the second drum-type gear 4b2 drives the second horizontal shaft 4b to rotate. The second transmission bevel gear 4b1 at the other end of the second horizontal shaft 4b drives the second cutter shaft bevel gear 2b1 to rotate, and the second cutter shaft bevel gear 2b1 then drives the second cutter shaft 2b, and the second cutting blade 3b on the lower end of the second cutter shaft 2b rotates at a high speed with the direction of rotation being opposite to the direction of rotation of the first cutting blade 3a. The engagement of the first drum-type gear 4a2 and the second drum-type gear 4b2 with the spline internal teeth is with sufficient flexibility such that a flexible transmission can be carried out, so as to automatically compensate for the coaxial error and spacing error of the first horizontal shaft 4a and the second horizontal shaft 4b, thereby adapting to a bumpy environment of grassland.

The grass cutter disc is provided with a grass cutter disc cover 11. The grass cutter disc cover 11 is connected with a discharge chute 11a at the middle portion of the rear side thereof. An rear outlet of the discharge chute 11a is connected with a front inlet of a grass collection basket 12. The grass collection basket 12 and the grass cutter disc cover 11 are fixedly mounted on the chassis. The first cutting blade 3a and the second cutting blade 3b rotate in opposite directions with one another and the grass cut down by the two cutting blades is discharged from the discharge chute 11a provided at the middle portion of the rear side of the grass cutter disc cover 11 and introduced into the grass collection basket 12 for temporary storage.

The two cutting blades have a phase position difference of 90 degrees, and therefore, collision of the two blades can be avoided to the full extent and continuous discharge of cut-down grass can be achieved.

The drum-type gear is formed by joining two symmetrical halves in the thickness direction and the joining locations are provided with tenons 4c and slots (not shown) that match tenons 4c respectively. The drum-type gear is divided into two bevel gears at the highest place of the addendum. After the two bevel gears are made separately, they are joined together back-to-back and tightened in the axial direction. With tenons 4c being inserted into the slots, fast alignment of the two halves (bevel gears) of the drum-type gear and precise positioning in the radial direction can be readily achieved.

The internally toothed sleeve 5 and the two cutter shaft seats are covered with drive mechanism shield 13 in order to keep grass cuttings and dust out, thereby improving the reliability of the drive system.

A tensioning wheel 8a is provided outside of the cutter disc driving belt 6, and the tensioning wheel 8a is fixed onto the long arm end of a cutter disc separation and engagement arm 8 which is further connected with a cutter disc separation and engagement cable 9 that is used to tension the tensioning wheel 8a. The cutter disc separation and engagement arm 8 is in the shape of “L” and is hinged onto the chassis at the corner by a separation and engagement arm spindle 8b. The cutter disc separation and engagement arm 8 has a short arm end that is hooked with a separation and engagement arm pullback spring 8d that can cause the tensioning wheel 8a to be released from the tension state. Upon the separation and engagement cable 9 being tensioned, the cutter disc separation and engagement arm 8 overcomes the stretching force of the separation and engagement arm pullback spring 8d and swings clockwisely, which causes the tensioning wheel 8a to be pressed tightly against the cutter disc driving belt 6, thereby driving the cutter shaft pulley 2a2 to rotate by the engine pulley 7b via the disc cutter disc driving belt 6.

A brake disc 10 is fixed under the engine pulley 7b and a mating brake block 8c is provided at the periphery of the brake disc 10. The driving end of the brake block 8c is fixed onto the long arm end of the cutter disc separation and engagement arm 8. Upon the separation and engagement cable 9 being released, the pull force of the separation and engagement arm pullback spring 8d causes the cutter disc separation and engagement arm 8 to swing counterclockwisely, and with the tensioning wheel 8a going away from the cutter disc driving belt 6, the brake block 8c is pressed tightly against the brake disc 10 and the cutter shaft pulley 2a2 is stopped immediately.

The embodiments described above are merely preferred ones for carrying out the present invention, and they are not intended to limit the scope of the present invention. The present invention may also be implemented in other embodiments in addition to these embodiments. Therefore, substitutions, modifications, alterations or changes which are equivalent to the embodiments described herein are within the scope of the present invention. The features that are not described in this application can be carried out by or using prior art, and thus will not be repeated herein for brevity.

What is claimed is:

1. A dual blade wide-format lawn mower, comprising:
a chassis,
an engine mounted on the chassis, and
a grass cutter disc mounted under the chassis,
wherein the grass cutter disc comprises two cutter shafts parallel with each other; the two cutter shafts each are mounted with a cutting blade on an lower end thereof; the two cutter shafts each are mounted with a cutter shaft bevel gear on a top end thereof, and each cutter shaft bevel gear is engaged with a transmission bevel gear mounted respectively on an outer end of a horizontal shaft; the two horizontal shafts are co-axial, and each horizontal shaft and the cutter shaft on the same side with said each horizontal shaft are supported respectively by a bearing in a cutter shaft seat; both cutter shaft seats are fixed onto the chassis, and opposing ends of the two horizontal shafts extend from the respective cutter shaft seat and each is mounted with a drum-type gear, and both drum-type gears are engaged respectively with spline internal teeth provided at both ends of an internally toothed sleeve; one cutter shaft has an upper end that extends from a top end of the respective cutter shaft seat and the upper end is mounted thereon with a cutter shaft pulley that is connected with an engine pulley via a cutter disc driving belt.

2. The dual blade wide-format lawn mower according to claim 1, wherein the grass cutter disc is provided with a grass cutter disc cover that is connected with a discharge chute at a middle portion of a rear side of the grass cutter disc cover, a rear outlet of the discharge chute is connected with a front inlet of a grass collection basket, and the grass collection basket and the grass cutter disc cover are fixedly mounted on the chassis.

3. The dual blade wide-format lawn mower according to claim 2, wherein the two cutting blades have a phase position difference of 90 degrees.

4. The dual blade wide-format lawn mower according to claim 1, wherein the drum-type gear is formed by joining two symmetrical halves in the thickness direction and the joining locations are provided with tenons and slots that match the tenons respectively.

5. The dual blade wide-format lawn mower according to claim 1, wherein the internally toothed sleeve and a periphery of the two cutter shaft seats are covered with a drive mechanism shield.

6. The dual blade wide-format lawn mower according to claim 1, wherein a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state.

7. The dual blade wide-format lawn mower according to claim 6, wherein a brake disc is fixedly provided under the engine pulley and a mating brake block is provided at a periphery of the brake disc, a driving end of the brake block is fixed onto the long arm end of the cutter disc separation and engagement arm.

8. The dual blade wide-format lawn mower according to claim 2, wherein a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state.

9. The dual blade wide-format lawn mower according to claim 8, wherein a brake disc is fixedly provided under the engine pulley and a mating brake block is provided at a periphery of the brake disc, a driving end of the brake block is fixed onto the long arm end of the cutter disc separation and engagement arm.

10. The dual blade wide-format lawn mower according to claim 3, wherein a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state.

11. The dual blade wide-format lawn mower according to claim 10, wherein a brake disc is fixedly provided under the engine pulley and a mating brake block is provided at a periphery of the brake disc, a driving end of the brake block is fixed onto the long arm end of the cutter disc separation and engagement arm.

12. The dual blade wide-format lawn mower according to claim 4, wherein a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state.

13. The dual blade wide-format lawn mower according to claim 12, wherein a brake disc is fixedly provided under the engine pulley and a mating brake block is provided at a periphery of the brake disc, a driving end of the brake block is fixed onto the long arm end of the cutter disc separation and engagement arm.

14. The dual blade wide-format lawn mower according to claim 5, wherein a tensioning wheel is provided outside of the cutter disc driving belt, and the tensioning wheel is fixed onto a long arm end of a cutter disc separation and engagement arm which is further connected with a cutter disc separation and engagement cable that is used to tension the tensioning wheel, the cutter disc separation and engagement arm is in “L” shape having a corner and is hinged onto the chassis at the corner with a separation and engagement arm spindle, the cutter disc separation and engagement arm has a short arm end that is hooked with a separation and engagement arm pullback spring that can cause the tensioning wheel to be released from the tension state.

15. The dual blade wide-format lawn mower according to claim 14, wherein a brake disc is fixedly provided under the engine pulley and a mating brake block is provided at a periphery of the brake disc, a driving end of the brake block is fixed onto the long arm end of the cutter disc separation and engagement arm.
